(19) United States
(12) Patent Application Publication
(10) Pub. No.: US 2022/0371809 A1
(43) Pub. Date: Nov. 24, 2022

(54) BAG PRODUCT CONTAINING FROZEN FOOD

(71) Applicant: MARUHA NICHIRO CORPORATION, Tokyo (JP)

(72) Inventors: Konomi TOKUZEN, Tokyo (JP); Kazunori TANI, Tokyo (JP); Shintarou HAGIWARA, Tokyo (JP); Tomoyoshi MIYAGAWA, Tokyo (JP)

(21) Appl. No.: 17/620,354

(22) PCT Filed: Jun. 26, 2020
(86) PCT No.: PCT/JP2020/025245

§ 371 Date: Dec. 17, 2021

(30) Foreign Application Priority Data
Jun. 28, 2019 (JP) 2019-122278

(51) Int. Cl. B65D 81/34; B65D 33/01; B65D 77/38; A23B 9/12; B65D 65/40

(52) U.S. Cl. CPC B65D 81/3461; B65D 33/01; B65D 77/38; A23B 9/12; B65D 65/40; B65D 2581/3422; A23V 2002/00

(57) ABSTRACT

A bag is formed in a gusset bag shape, and sections respectively extending along the short-side portions of a pair of front and back principal-surface film portions are each joined together as end joint portions, to thereby seal frozen food inside the bag. In each end joint portion: the pair of V-shape segments of a side-surface film portion, which is folded inward in a V-shape, is not joined together; and an end of the side-surface film portion is joined only to the ends of the pair of front and back principal-surface film portions extending along the respective short-side portions thereof, to thereby form a side joint region formed so as to expand in a V-shape, each side joint region being formed by joining the end of the side-surface film portion and the ends of the respective principal-surface film portions extending along the short-side portion thereof.

### CROSS-REFERENCE TO RELATED APPLICATIONS

This application is the U.S. national phase of International Application No. PCT/JP2020/025245 filed Jun. 26, 2020 which designated the U.S. and claims priority to Japanese Patent Application No. 2019-122278 filed Jun. 28, 2019, the entire contents of each of which are hereby incorporated by reference.

### BACKGROUND OF THE INVENTION

### Field of the Invention

The present invention relates to a frozen food-containing bag product, and more specifically, to a frozen food-containing bag product that allows thawed or heated food to be eaten while being kept in a bag, without being transferred to another container.

### Description of the Related Art

As microwave ovens have become commonplace, frozen foods and heated/pressurized foods, such as retort foods, have become even more widely purchased by many consumers. Frozen food products are typically distributed in a state where a frozen food is contained in a bag, such as a pouch, preferably having hermetic sealability and lightproof properties. Such bags, e.g. pouches, having hermetic sealability and lightproof properties may include metal foil, such as aluminum, as a packaging material. In such cases, the bag cannot be used as-is in a microwave oven. Thus, when heating or thawing the frozen food contained in the bag in a microwave oven, the frozen food needs to be transferred to another container, such as plateware, before being thawed or heated.

Further, in recent years, frozen foods packed in microwavable bags have also become commonplace. Such microwavable bags, which have been made possible by the development of a special type of film material having excellent heat resistance and preservability, are provided with a steam-release mechanism through which steam arising from the frozen food contained in the bag can be discharged (see, for example, Patent Literature 1). However, such frozen foods contained in microwavable bags are, after being thawed or heated, typically transferred to another container, such as plateware, before consumption.

### CITATION LIST

### Patent Literature

Patent Literature 1: US 2003/031763 A1

### SUMMARY OF THE INVENTION

Meanwhile, recent years have seen a growing preference toward economization, as well as diversification in the manner/style of eating and a preference toward convenience and time-saving. It is thus anticipated that consumers, particularly young consumers, may want to thaw or heat, in a microwave oven, a frozen food preferably contained in a bag and then easily eat the thawed/heated food right from the bag, without the need to transfer the food to another container such as plateware. There is thus an expectation for the development of a novel bag product that enables such easy consumption of food.

An objective of the present invention is to provide a frozen food-containing bag product, as well as a method for using the frozen food-containing bag product, with which a bag-contained frozen food can be thawed or heated in a microwave oven and then be easily eaten while being kept in the bag, without the need to be transferred to another container such as plateware.

The present invention achieves the aforementioned objective by providing a frozen food-containing bag product constructed such that a frozen food contained in a bag can be thawed or heated using a microwave oven and the thawed or heated food can be eaten while being kept in the bag without being transferred to another container, wherein:

the bag is formed using a film material so as to include
a pair of front and back principal-surface film portions, each having a rectangular front-view shape, and
a side-surface film portion being folded inward in a V-shape and tucked-in at a section extending along at least one of long-side portions which exist on both sides of each of the principal-surface film portions;

sections respectively extending along short-side portions, which exist on both sides of each of the front and back principal-surface film portions, are each joined together as joint portions, to thereby seal the frozen food inside the bag;

a steam discharging portion is formed in one of the front and back principal-surface film portions;

in each of the joint portions respectively formed along the short-side portions on both sides of the pair of front and back principal-surface film portions,
the side-surface film portion folded inward in a V-shape is not joined together, and
an end of the side-surface film portion is joined only to the front and back principal-surface film portions' ends extending along the respective short-side portions on both sides of the pair of front and back principal-surface film portions, to thereby form a joint region formed so as to expand in a V-shape, the joint region being formed by joining the side-surface film portion's end and the principal-surface film portions' ends extending along the short-side portion; and

the frozen food-containing bag product is constructed such that, in a state where the bag, containing the thawed or heated food and having been taken out from a microwave oven, is arranged in a manner that the side-surface film portion on the side of one of the long-side portions of the principal-surface film portions comes to a lower side, the inwardly-folded V-shape state of the side-surface film portion arranged on the lower side is opened-up by employing the weight of the thawed or heated food, and the side-surface film portion, which is arranged on the lower side and whose inwardly-folded state has been opened-up, serves as a placement portion and is placed on a receiving surface, on which the bag is to be placed, by employing the weight of the thawed or heated food, a section on the side of the other long-side portion of the principal-surface film portions is cut away along a long-side direction to thereby form a take-out opening in a manner that the food can be taken out through the formed take-out opening and be eaten.

It is preferable that, in the frozen food-containing bag product of the present invention:
the bag is formed in a gusset bag shape using a film material so as to include a pair of front and back principal-surface film portions, each having a rectangular front-view shape, and
   a pair of left and right side-surface film portions, each being folded inward in a V-shape and tucked-in at a section extending along one of the respective long-side portions which exist on both sides of each of the principal-surface film portions;

sections respectively extending along the short-side portions, which exist on both sides of each of the front and back principal-surface film portions, are each joined together as joint portions, to thereby seal the frozen food inside the bag;

a steam discharging portion is formed in one of the front and back principal-surface film portions; and

in each of the joint portions respectively formed along the short-side portions on both sides of the pair of front and back principal-surface film portions, each of the left and right side-surface film portions folded inward in a V-shape is not joined together, and

an end of each of the side-surface film portions is joined only to the front and back principal-surface film portions' ends extending along the respective short-side portions on both sides of the pair of front and back principal-surface film portions, to thereby form a joint region formed so as to expand in a V-shape, the joint region being formed by joining the side-surface film portion's end and the principal-surface film portions' ends extending along the short-side portion.

It is preferable that, in the frozen food-containing bag product of the present invention, the film material forming the bag is a laminate film material made from:a synthetic resin-made stretched film; anda synthetic resin-made unstretched film having heat-sealability and bonded to an inner side of the synthetic resin-made stretched film.

It is preferable that, in the frozen food-containing bag product of the present invention, the steam discharging portion includes:
a low-melting-point heat-seal agent or release agent provided between the synthetic resin-made stretched film and the synthetic resin-made unstretched film and applied to the synthetic resin-made stretched film so as to extend in a belt-like shape; and
a cut line that is linearly cut in the synthetic resin-made stretched film so as to longitudinally traverse the belt-like zone, in which the low-melting-point heat-seal agent or release agent has been applied, along the extending direction of the belt-like zone, and
   extend out from the belt-like zone up to a zone where the low-melting-point heat-seal agent or release agent is not applied.

It is preferable that, in the frozen food-containing bag product of the present invention, the steam discharging portion extends in a direction along the long-side direction of said one of the principal-surface film portions, and is provided closer to the side of the other long-side portion opposite from the side-surface film portion that becomes the placement portion on the side of said one of the long-side portions.

It is preferable that, in the frozen food-containing bag product of the present invention, the cut line of the steam discharging portion functions as a cut-away guide line when forming the take-out opening by cutting away the principal-surface film portions along the long-side direction after thawing or heating the food contained in the bag.

It is preferable that, in the frozen food-containing bag product of the present invention, the frozen food contained in the bag is frozen cooked rice.

Also, the present invention achieves the aforementioned objective by providing a method for using the aforementioned frozen food-containing bag product, the method involving:

placing the bag product, which has the frozen food contained in the bag, in a microwave oven such that one of the principal-surface film portions having the bag's steam discharging portion faces upward;

thawing or heating the frozen food while causing steam to be discharged from the steam discharging portion by operating the microwave oven for a predetermined time with which the contained frozen food can be thawed or heated;

then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and

by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

### BRIEF DESCRIPTION OF THE DRAWINGS

FIG. 1 is a schematic perspective view of a frozen food-containing bag product according to a preferred embodiment of the invention.

FIG. 2 is a schematic front view, wherein FIG. 1 is viewed from direction A.

FIG. 3 is a schematic perspective view of a bag before containing a frozen food.

FIGS. 4(a) to 4(c) and 4(e) are cross-sectional views taken along line B-B of FIG. 1 to explain a function of a steam discharging portion, and FIGS. 4(d) and 4(f) are schematic perspective views of the steam discharging portion.

FIG. 5 is a schematic perspective view for explaining a method for using a frozen food-containing bag product according to a preferred embodiment of the invention.

FIG. 6 is a schematic perspective view for explaining a method for using a frozen food-containing bag product according to a preferred embodiment of the invention.

FIG. 7 is a schematic perspective view for explaining a method for using a frozen food-containing bag product according to a preferred embodiment of the invention.

FIG. 8 is a schematic perspective view for explaining a method for using a frozen food-containing bag product according to a preferred embodiment of the invention.

FIG. 9 is a schematic perspective view for explaining a method for using a frozen food-containing bag product according to a preferred embodiment of the invention.

FIG. 10(a) is a schematic perspective view of a frozen food-containing bag product according to another preferred embodiment of the invention, and FIG. 10(b) is a schematic front view, wherein FIG. 10(a) is viewed from direction C.

### DESCRIPTION OF THE PREFERRED EMBODIMENTS

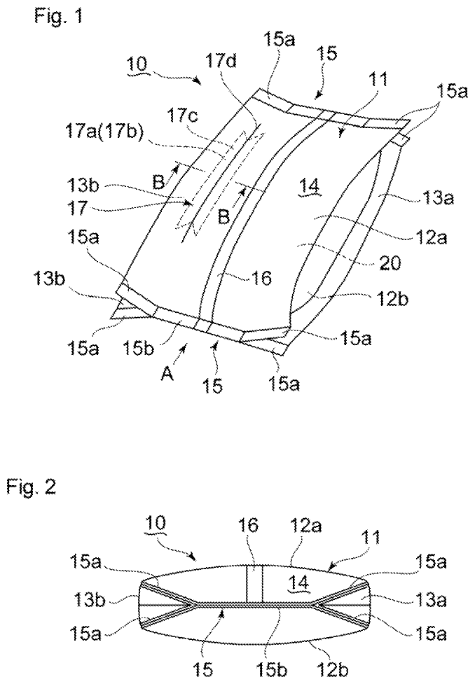

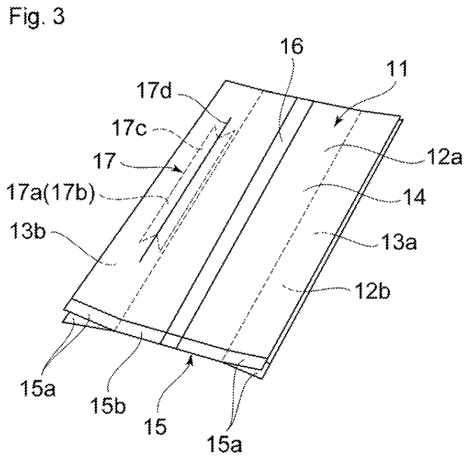

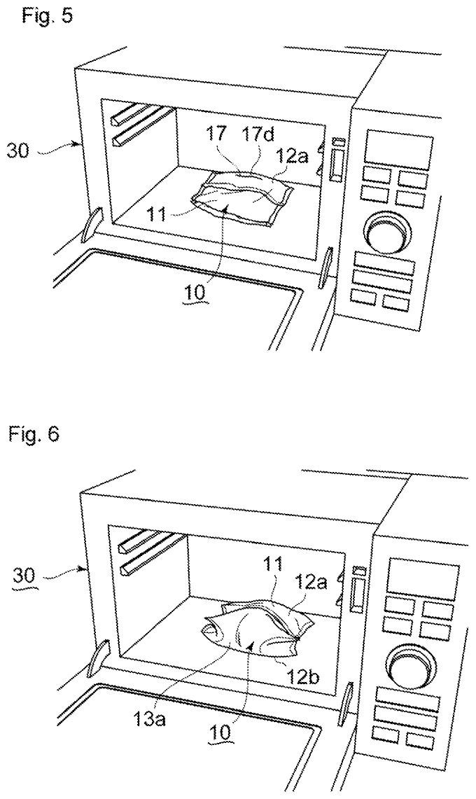

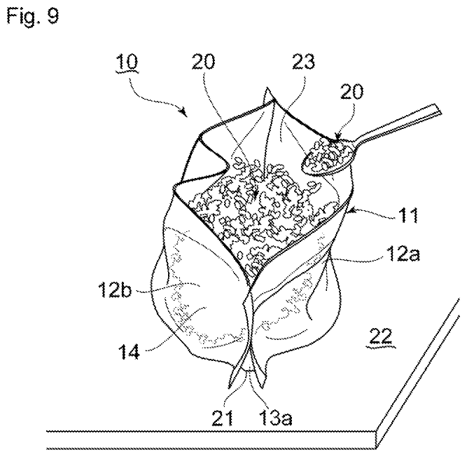

A frozen food-containing bag product 10 according to a preferred embodiment of the invention as illustrated in FIGS. 1 and 2 is manufactured as a single-serving bag product, wherein a frozen food 20 (see FIG. 9) which has been cooked and then frozen, preferably frozen cooked rice such as gomoku fried rice (fried rice including various ingredients), kimchi fried rice, pilaf, chicken rice (rice fried with chicken), etc., is contained in a bag 11 having a rectangular planar-view shape (see FIG. 3) and formed using a synthetic resin-made film material 14. In the frozen food-containing bag product 10 of the present embodiment, the bag 11 does not include a metal foil such as aluminum. Also, by including a steam discharging portion 17, the bag product can be placed as-is in a microwave oven 30 (see FIGS. 5 and 6) to thaw or heat the frozen food. Further, the bag product functions such that the thawed or heated food 20 can be easily eaten while being kept in the bag 11 (see FIG. 9), without being transferred to another container such as plateware.

The frozen food-containing bag product 10 of the present embodiment is a bag product constructed such that the frozen food 20 contained in the bag 11 can be thawed or heated using a microwave oven 30 and the thawed or heated food 20 can be eaten while being kept in the bag 11 without being transferred to another container, wherein: as illustrated in FIGS. 1 to 3, the bag 11 is formed, preferably in a gusset bag shape, using a film material 14 so as to include a pair of front and back principal-surface film portions 12a, 12b each having a rectangular front-view shape, and preferably a pair of left and right side-surface film portions 13a, 13b, each being folded inward in a V-shape and tucked-in at a section extending along at least one of, and preferably along both, the long-side portions which exist on both sides of each of the principal-surface film portions 12a, 12b. Sections respectively extending along the short-side portions, which exist on both sides of each of the front and back principal-surface film portions 12a, 12b, are each joined together as end joint portions 15, to thereby seal the frozen food 20 inside the bag. A steam discharging portion 17 is formed in one film portion 12a of the front and back principal-surface film portions 12a, 12b.

In each of the end joint portions 15 respectively formed along the short-side portions on both sides of the pair of front and back principal-surface film portions 12a, 12b: the pair of segments constituting the V-shape of each of the side-surface film portions 13a, 13b, which are preferably provided as a pair on both left and right sides and which are each folded inward in a V-shape, are not joined together; whereas an end of each of the side-surface film portions 13a, 13b is joined only to the ends of the pair of front and back principal-surface film portions 12a, 12b extending along the respective short-side portions on both sides thereof, to thereby form a side joint region 15a formed so as to expand in a V-shape, wherein the respective side joint regions 15a are formed by joining the respective ends on both sides of each side-surface film portion 13a, 13b with corresponding ends extending along the respective short-side portions on both sides of the principal-surface film portions 12a, 12b.

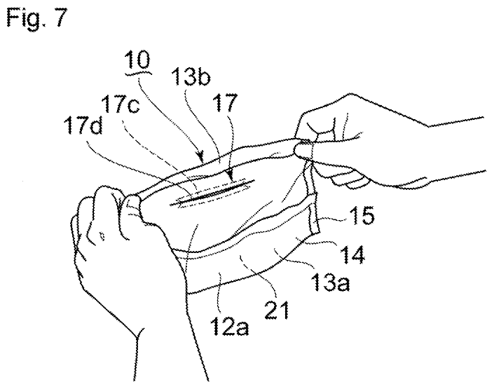

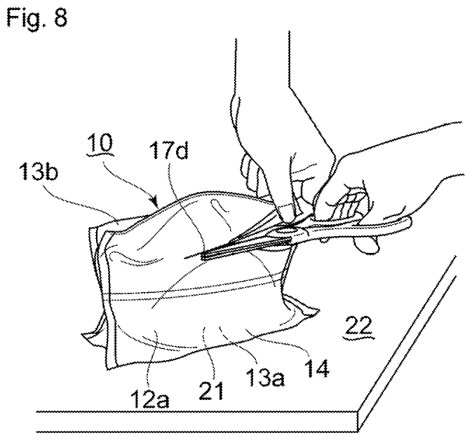

As illustrated in FIGS. 5 to 9, the bag 11, containing the thawed or heated food 20 and having been taken out from a microwave oven 30, is arranged in a manner that the side-surface film portion 13a on the side of one of the long-side portions of the principal-surface film portions 12a, 12b comes to the lower side (see FIG. 7); the inwardly-folded V-shape state of the side-surface film portion 13a arranged on the lower side is opened-up by employing the weight of the thawed or heated food; and the side-surface film portion 13a, which is arranged on the lower side and whose inwardly-folded state has been opened-up, serves as a placement portion 21 and is placed on a receiving surface 22, on which the bag is to be placed, by employing the weight of the thawed or heated food 20 (see FIG. 8). In this state, a section on the side of the other long-side portion of the principal-surface film portions 12a, 12b is cut away along the long-side direction to thereby form a take-out opening 23 in a manner that the food 20 can be taken out through the formed take-out opening 23 and be eaten (see FIG. 9).

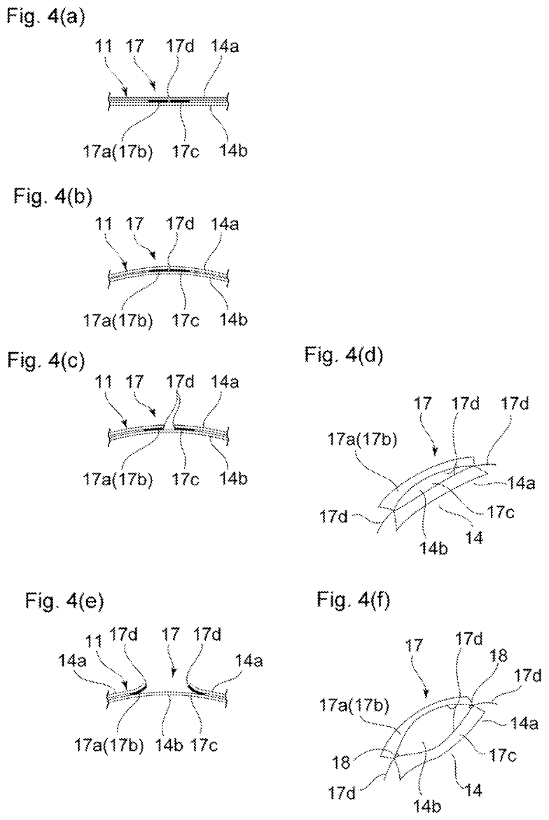

Further, as illustrated in FIGS. 4(a) to 4(c) and 4(e), in the present embodiment, the film material 14 forming the bag 11 is a laminate film material made from: a synthetic resin-made stretched film 14a; and a synthetic resin-made unstretched film 14b having heat-sealability and bonded to an inner side of the synthetic resin-made stretched film 14a. As illustrated in FIG. 1 and FIGS. 4(a) to 4(f), the steam discharging portion 17 includes: a low-melting-point heat-seal agent 17a or release agent 17b provided between the synthetic resin-made stretched film 14a and the synthetic resin-made unstretched film 14b and applied to the synthetic resin-made stretched film 14a so as to extend in a belt-like shape; and a cut line 17d that is linearly cut in the synthetic resin-made stretched film 14a so as to longitudinally traverse the belt-like zone 17c, in which the low-melting-point heat-seal agent 17a or release agent 17b has been applied, along the extending direction of the belt-like zone, and extend out from the belt-like zone 17c up to a zone where the low-melting-point heat-seal agent 17a or release agent 17b is not applied.

Further, as illustrated in FIGS. 1 and 3, in the present embodiment, the steam discharging portion 17 extends in a direction along the long-side direction of the aforementioned one principal-surface film portion 12a, and is provided closer to the side of the other long-side portion opposite from the side-surface film portion 13a that becomes the placement portion 21 on the side of the aforementioned one of the long-side portions.

In the present embodiment, the bag 11 containing the frozen food 20 can be formed by using, as the film material 14, a laminate film material obtained by preferably bonding together a synthetic resin-made stretched film 14a and a synthetic resin-made unstretched film 14b having heat-sealability. The bag 11 can be formed, for example, by using a single sheet of a rectangular, laterally-long, belt-shaped film material 14 having a width being substantially the same length as the length of the principal-surface film portion 12a, 12b in the long-side direction, and having a length being about three times the length of the principal-surface film portion 12a, 12b in the short-side direction.

More specifically, the bag 11 can be formed using a single sheet of rectangular, laterally-long film material 14 as follows, for example. First, the film material 14 is curved into a ring shape by arranging the heat-sealable synthetic resin-made unstretched film 14b on the inner side, and then, with the inner sides consisting of the synthetic resin-made unstretched film 14b facing each other, the edge regions at both ends in the laterally-long direction are heat-sealed into a longitudinal joint portion 16 extending along the long-side direction, to thereby form the film material 14 into a tubular shape. Then, as illustrated in FIG. 3, the tubular-shaped film material 14 is placed such that, for example, the longitudinal joint portion 16 longitudinally traverses the center region, in the short-side direction, of one principal-surface film portion 12a; and then, between the one principal-surface film portion 12a and the other principal-surface film portion 12b superposed thereon, a pair of left and right side-surface film portions 13a, 13b are folded inward in a V-shape and tucked-in at respective sections extending along the long-side portions on both sides of the principal-surface film portions 12a, 12b, so that the film material is folded and flattened. In this state, an end extending along one short-side portion of the folded film material 14 is heat-sealed as an end joint portion 15. In this way, it is possible to form a bag 11, preferably having a gusset bag shape, before containing food 20.

For the synthetic resin-made stretched film 14a constituting the film material 14 for forming the bag 11, it is possible to use a general-purpose stretched film made, for example, from polyethylene terephthalate (PET), polypropylene (PP), polyamide (PA), etc. Examples of the stretched film may include a uniaxially stretched film or a biaxially stretched film. A uniaxially stretched film has a property of being hard to stretch in one direction, i.e., the longitudinal direction or the lateral direction. A biaxially stretched film is a film that is hard to stretch in both the longitudinal and lateral directions, and has excellent machine suitability for such processes as printing, laminated compositing, etc., and can thus be preferably used as a base material.

For the synthetic resin-made unstretched film 14b constituting the film material 14, it is possible to preferably use an unstretched film made from e.g. polyethylene (PE) or polypropylene (PP), which is widely employed as sealants preferably for packaging-laminate materials and which is easily stretchable in both the longitudinal and lateral directions and has stable heat-sealability and heat-seal strength in addition to being resistant to shock.

Further, in the present embodiment, the bag 11, which is preferably formed in a gusset bag shape, is made such that the inner layer of the film material 14 is constituted by the synthetic resin-made unstretched film 14b having heat-sealability and the outer layer is constituted by the synthetic resin-made stretched film 14a that does not have heat-sealability. Therefore, at the end of each inwardly-folded V-shaped side-surface film portion 13a, 13b in the end joint portion 15 on the side having been heat-sealed, the respective outer surfaces of the segments constituting the V-shape are not joined together, whereas only the inner surfaces are joined as V-shaped side joint regions 15a to the respective inner surfaces of the ends of the pair of front and back principal-surface film portions 12a, 12b extending along the short-side portion thereof. Further, in the end joint portion 15 formed along the short-side portion of the pair of front and back principal-surface film portions 12a, 12b, a region between the side joint regions 15a, which exist on both sides, is formed into a midsection joint region 15b by joining together the respective inner surfaces of the ends of the pair of front and back principal-surface film portions 12a, 12b extending along the short-side portion thereof. In this way, each side joint region 15a, which is formed by joining the end of the side-surface film portion 13a, 13b and the ends of the principal-surface film portions 12a, 12b extending along the short-side portion thereof, is formed so as to expand in a V-shape (wedge shape), with each end of the midsection joint region 15b constituting the apex of the V-shape, as illustrated in FIG. 2.

After heat-sealing the respective ends of the pair of front and back principal-surface film portions 12a, 12b, which extend along one of the short-side portions in the folded film material 14, to form the end joint portion 15 and thereby form the gusset bag-shaped bag 11 before containing the food 20, a predetermined amount of frozen food 20 is introduced into the bag 11 by employing, as a supply opening, the end along the other short-side portion which has not yet been heat-sealed. Then, the bag 11's end along the other short-side portion is heat-sealed to form an end joint portion 15, like the end along the aforementioned one short-side portion. In this way, the frozen food-containing bag product 10 of the present embodiment can be formed, as illustrated in FIG. 1.

Similar to the aforementioned one end joint portion 15, also in the other end joint portion 15 which has been heat-sealed, at the end of each inwardly-folded V-shaped side-surface film portion 13a, 13b, the respective outer surfaces of the segments constituting the V-shape are not joined together, whereas only the inner surfaces are joined as V-shaped side joint regions 15a to the respective inner surfaces of the ends of the pair of front and back principal-surface film portions 12a, 12b extending along the short-side portion thereof. Further, in the end joint portion 15 formed along the short-side portion of the pair of front and back principal-surface film portions 12a, 12b, a region between the side joint regions 15a, which exist on both sides, is formed into a midsection joint region 15b by joining together the respective inner surfaces of the ends of the pair of front and back principal-surface film portions 12a, 12b extending along the short-side portion thereof. In this way, each side joint region 15a, which is formed by joining the end of the side-surface film portion 13a, 13b and the ends of the principal-surface film portions 12a, 12b extending along the short-side portion thereof, is formed so as to expand in a V-shape (wedge shape), with each end of the midsection joint region 15b constituting the apex of the V-shape, as illustrated in FIG. 2.

Further, in the present embodiment, a belt-like zone 17c is provided in advance in a predetermined position of the single sheet of rectangular, laterally-long film material 14 by applying the low-melting-point heat-seal agent 17a or release agent 17b to the synthetic resin-made stretched film 14a so as to be interposed between the synthetic resin-made stretched film 14a and the synthetic resin-made unstretched film 14b. Further, a cut line 17d is cut linearly so as to longitudinally traverse the belt-like zone 17c. In this way, when the bag 11 is formed into a gusset bag shape, as illustrated in FIG. 3, the steam discharging portion 17 is formed in a manner extending in a direction along the long-side direction of the aforementioned one principal-surface film portion 12a, and being provided closer to the side-surface film portion 13b on the other long-side portion side opposite from the side-surface film portion 13a that becomes the placement portion 21 on the side of the aforementioned one long-side portion.

Herein, the steam discharging portion 17 has a structure similar to the mechanism of a discharging portion for discharging steam as disclosed in Japanese Patent No. 4817583. As illustrated in FIG. 1 and FIGS. 4(a) to 4(f), the steam discharging portion includes: a low-melting-point heat-seal agent 17a or release agent 17b provided between the synthetic resin-made stretched film 14a and the synthetic resin-made unstretched film 14b and applied to the synthetic resin-made stretched film 14a so as to extend in a belt-like shape; and a cut line 17d that is linearly cut only in the synthetic resin-made stretched film 14a so as to longitudinally traverse the belt-like zone 17c, in which the low-melting-point heat-seal agent 17a or release agent 17b has been applied, along the extending direction of the belt-like zone, and extend out from the belt-like zone 17c up to a zone where the low-melting-point heat-seal agent 17a or release agent 17b is not applied. In the present embodiment, the belt-like zone 17c, which is formed by applying the low-melting-point heat-seal agent 17a or release agent 17b, may have, for example, a width of around 45 to 145 mm as necessary, and both ends of the belt-like zone may be formed preferably in the shape of an inverse yagasuri (arrow fletching) pattern. The cut line 17d may be formed as a straight line or a broken line.

As will be described further below, the steam discharging portion 17 functions such that, when the bag product 10 having the frozen food 20 sealed in the bag 11 is placed in a microwave oven 30 and the frozen food 20 is to be thawed or heated, water vapor arising from the contained frozen food 20 can be discharged while moderately steaming the contained frozen food 20. More specifically, when the bag product 10 is placed in a microwave oven 30 and is subjected to a thawing or heating process, the moisture in the contained frozen food 20 vaporizes as steam (water vapor), and the steam and air are mixed together to increase the pressure inside the bag 11. Thus, the inner-layer synthetic resin-made unstretched film 14b in the steam discharging portion 17 starts to stretch in a direction perpendicular to the cut line 17d, as illustrated in FIGS. 4(b) and 4(c), while spreading the synthetic resin-made stretched film 14a which is bonded to the outer side of the film 14b.

A further increase in pressure inside the bag 11 causes the cut region created by the cut line 17d in the synthetic resin-made stretched film 14a to spread open, and in association therewith, the stretching region of the synthetic resin-made unstretched film 14b further expands. Then, peeling between the synthetic resin-made stretched film 14a and the synthetic resin-made unstretched film 14b starts at the zone where the heat-seal agent or release agent has been applied, this peeling being caused either by melting in cases of application of a low-melting-point heat-seal agent 17a to the synthetic resin-made stretched film 14a, or by low friction in cases of application of a release agent 17b to the synthetic resin-made stretched film 14a. Then, as illustrated in FIGS. 4(c) and 4(d), the synthetic resin-made stretched film 14a on the outer layer starts to open up at the cut line 17d in the zone where the low-melting-point heat-seal agent 17a or release agent 17b has been applied.

Even after the synthetic resin-made stretched film 14a has started to open up at the area of the cut line 17d, the synthetic resin-made unstretched film 14b tries to keep stretching as illustrated in FIG. 4(e). However, the synthetic resin-made unstretched film 14b stretches only in the region of the belt-like zone 17c where the heat-seal agent 17a or release agent 17b has been applied, and does not stretch in other regions where no agent has been applied. Thus, stress concentrates on the boundary section between the area of the belt-like zone 17c, in which the low-melting-point heat-seal agent 17a or release agent 17b has been applied, and the area where no agent has been applied. This results in a small hole 18 being opened in the synthetic resin-made unstretched film 14b at the corner in the center of the preferably inverse yagasuri (arrow fletching) shape, which is where the cut line 17d intersects with each end of the belt-like zone 17c where the synthetic resin-made stretched film 14a has opened up, as illustrated in FIG. 4(f).

When the respective small holes 18 open up in the synthetic resin-made unstretched film 14b, the water vapor within the bag 11 passes through the opened small holes 18 and the region where the cut line 17d in the synthetic resin-made stretched film 14a has opened up, and is discharged smoothly to outside the bag 11. Further, as a result of the water vapor being discharged outside, the pressure inside the bag 11 decreases and the stretch ratio of the synthetic resin-made unstretched film 14b also decreases, which causes the opened small holes 18 to shrink and become substantially blocked off.

When the small holes 18 become closed, the pressure inside the bag 11 rises again and the stretch ratio of the synthetic resin-made unstretched film 14b increases, which causes the small holes 18 to open up again. In this way, the water vapor inside the bag 11 can again be discharged to the outside, which reduces the pressure inside the bag 11. The opening area of the small holes 18 expands and contracts in this way, and thereby, the pressure inside the bag 11 decreases and increases repeatedly. This allows the pressure inside the bag 11 to be kept stably within a given range that is higher than atmospheric pressure, thus making it possible to achieve an effect of moderately steaming the thawed or heated food 20 and also shorten the time for thawing or heating.

The frozen food-containing bag product 10 of the present embodiment having the aforementioned configuration can be used as follows, thereby allowing a consumer to easily eat the thawed or heated food. That is, as illustrated in FIGS. 5 to 9, for example, a consumer who purchased the aforementioned frozen food-containing bag product 10 places the bag product 10, which has the frozen food 20 contained in the bag 11, in a microwave oven 30 such that one principal-surface film portion 12a of the bag 11 having the steam discharging portion 17 faces upward (see FIG. 5), and operates the microwave oven 30 for a predetermined time with which the contained frozen food 20 can be thawed or heated, to thereby thaw or heat the frozen food 20 while causing steam to be discharged from the steam discharging portion 17.

At the time of thawing or heating the frozen food 20, moisture contained in the frozen food 20 within the bag vaporizes as water vapor (steam), and the steam and air are mixed together to thereby increase the pressure inside the bag 11 and expand the bag 11, which makes it possible to open up the inwardly-folded V-shape state of the pair of left and right side-surface film portions 13a, 13b respectively tucked-in at the respective sections extending along the long-side portions on both sides of the pair of front and back principal-surface film portions 12a, 12b, as illustrated in FIG. 6. Further, as described above, by discharging the steam inside the bag 11 while causing expansion/contraction of the opening area of the small holes 18 (see FIG. 4(f)) opened in sections where the cut line 17d intersects with both ends of the belt-like zone 17c in the steam discharging portion 17, the pressure inside the bag 11 is decreased and increased repeatedly, which allows the pressure inside the bag 11 to be kept stably within a given range that is higher than atmospheric pressure, thus making it possible to achieve an effect of moderately steaming the thawed or heated food 20.

After thawing or heating the frozen food 20 while causing steam to be discharged from the steam discharging portion 17 by operating the microwave oven 30 for a predetermined time with which the contained frozen food 20 can be thawed or heated, the bag product 10 containing the thawed or heated food is taken out from the microwave oven 30, and the thawed or heated food 20 is moved to the side of the side-surface film portion 13a which is located on the side of the aforementioned one long-side portion of the bag 11, as illustrated in FIG. 7. In this way, the side-surface film portion 13a on the side of the aforementioned one long-side portion, whose inwardly-folded V-shaped state has been opened up by the expansion of the bag 11, is kept open by the weight of the thawed or heated food 20, to thereby form a placement portion 21 by means of the side-surface film portion 13a on the side of the aforementioned one long-side portion.

Then, as illustrated in FIG. 8, by employing the weight of the thawed or heated food 20, the formed placement portion 21 is placed in a stable state on a receiving surface 22 on which the bag is to be placed, such as a table. In this state, by employing the cut line 17d preferably cut in the steam discharging portion 17 as a cut-away guide line, a section on the side of the other long-side portion of the principal-surface film portions 12a, 12b is cut away along the long-side direction. Thus, a take-out opening 23 can be formed smoothly, such that the thawed or heated food 20 can be taken out through the take-out opening 23, as illustrated in FIG. 9. A consumer can take out the thawed or heated food 20 from the take-out opening 23, which has a considerable size, in a state where the formed placement portion 21 is placed stably on the receiving surface 22 and can easily eat the food while keeping the food in the bag 11, without transferring it to another container such as plateware. Also, after finishing eating the contained food 20, the consumer can easily discard the bag 11 that contained the food 20 as appropriate.

Thus, according to the frozen food-containing bag product 10 of the present embodiment, the frozen food 20 contained in the bag 11 can be thawed or heated in a microwave oven 30 and then be easily eaten while being kept in the bag 11, without being transferred to another container such as plateware.

Particularly, according to the frozen food-containing bag product 10 of the present embodiment, in each of the end joint portions 15 respectively formed along the short-side portions on both sides of the pair of front and back principal-surface film portions 12a, 12b, the pair of segments constituting the V-shape of each of the inwardly-folded V-shaped side-surface film portions 13a, 13b are not joined together; whereas an end of each of the side-surface film portions 13a, 13b is joined only to the ends of the pair of front and back principal-surface film portions 12a, 12b extending along the respective short-side portions on both sides of the front and back principal-surface film portions, to thereby form a side joint region 15a formed so as to expand in a V-shape, wherein the respective side joint regions 15a are formed by joining the respective ends on both sides of each side-surface film portion 13a, 13b with corresponding ends extending along the respective short-side portions on both sides of the principal-surface film portions 12a, 12b. With this configuration, at the time of opening up the inwardly-folded V-shaped state of the side-surface film portion 13a on the side of one long-side portion by the weight of the thawed or heated food 20 and placing the placement portion 21, which is formed by the side-surface film portion 13a on the side of one long-side portion, on a receiving surface 22, each end joint portion 15's side joint region 15a expands in a V-shape and directly contacts the receiving surface 22, thereby preventing the bag 11 from becoming unstable. Thus, the placement portion 21 can be placed on the receiving surface 22 in a stabler state, thereby allowing the thawed or heated food 20 contained in the bag 11 to be eaten even more easily.

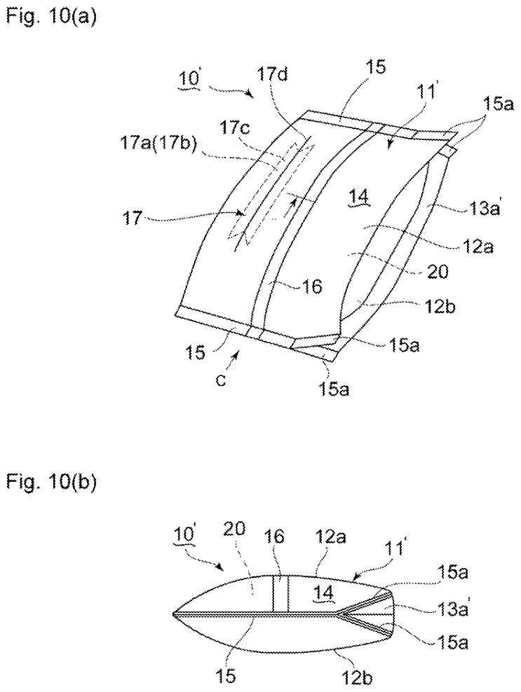

FIGS. 10(a) and 10(b) illustrate a frozen food-containing bag product 10′ according to another preferred embodiment of the present invention. As regards the frozen food-containing bag product 10′ according to this other embodiment illustrated in FIGS. 10(a) and 10(b), features that are different from those of the frozen food-containing bag product 10 of the foregoing embodiment are mainly described below, and features that are the same are accompanied by the same reference signs and explanation thereon is omitted. The explanation regarding the frozen food-containing bag product 10 of the foregoing embodiment applies as appropriate to features that are not particularly described below. In the frozen food-containing bag product 10′ according to another embodiment as illustrated in FIGS. 10(a) and 10(b), a side-surface film portion 13a′, which is to be tucked-in at a section extending along a long-side portion of the pair of principal-surface film portions 12a, 12b, is tucked-in in an inwardly-folded V-shaped state at a section along only one long-side portion, which serves as the “at least one of the long-side portions which exist on both sides of each of the principal-surface film portions 12a, 12b.” The other features are the same as those in the frozen food-containing bag product 10 of the foregoing embodiment.

Also according to the frozen food-containing bag product 10′ of this other embodiment illustrated in FIGS. 10(a) and 10(b): the bag 11′, containing the thawed or heated food 20 and having been taken out from a microwave oven 30, can be arranged in a manner that the side-surface film portion 13a ′ on the side of one of the long-side portions of the principal-surface film portions 12a, 12b comes to the lower side; the inwardly-folded V-shape state of the side-surface film portion 13a ′ arranged on the lower side can be opened-up by employing the weight of the thawed or heated food; the side-surface film portion 13a′, which is arranged on the lower side and whose inwardly-folded state has been opened-up, can serve as a placement portion and can be placed on a receiving surface by employing the weight of the thawed or heated food 20; and in this state, a section on the side of the other long-side portion of the principal-surface film portions 12a, 12b can be cut away along the long-side direction to thereby form a take-out opening in a manner that the food 20 can be taken out through the formed take-out opening and be eaten. Thus, it is possible to achieve the same effects as those of the frozen food-containing bag product 10 of the foregoing embodiment.

It should be noted that the present invention is not limited to the foregoing embodiments, and various modifications are possible. For example, the frozen food contained in the bag is not limited to frozen cooked rice, and may be any of various other frozen foods, such as frozen noodles, frozen fried foods, etc. Further, the film material forming the bag does not necessarily have to be a laminate film material made from a synthetic resin-made stretched film and a synthetic resin-made unstretched film bonded to the inner side thereof and having heat-sealability. The steam discharging portion does not necessarily have to include: a low-melting-point heat-seal agent or release agent applied between the synthetic resin-made stretched film and the synthetic resin-made unstretched film; and a cut line being cut so as to longitudinally traverse the zone in which the heat-seal agent or release agent has been applied.

### INDUSTRIAL APPLICABILITY

With the frozen food-containing bag product, or the method for using the frozen food-containing bag product, according to the present invention, a bag-contained frozen food can be thawed or heated in a microwave oven and then be easily eaten while being kept in the bag, without the need to be transferred to another container such as plateware.

1. A frozen food-containing bag product constructed such that a frozen food contained in a bag can be thawed or heated using a microwave oven and the thawed or heated food can be eaten while being kept in the bag without being transferred to another container, wherein:
the bag is formed using a film material so as to comprise
a pair of front and back principal-surface film portions, each having a rectangular front-view shape, and
a side-surface film portion being folded inward in a V-shape and tucked-in at a section extending along at least one of long-side portions which exist on both sides of each of the principal-surface film portions;
sections respectively extending along short-side portions, which exist on both sides of each of the front and back principal-surface film portions, are each joined together as joint portions, to thereby seal the frozen food inside the bag;
a steam discharging portion is formed in one of the front and back principal-surface film portions;
in each of the joint portions respectively formed along the short-side portions on both sides of the pair of front and back principal-surface film portions,
the side-surface film portion folded inward in a V-shape is not joined together, and
an end of the side-surface film portion is joined only to the front and back principal-surface film portions' ends extending along the respective short-side portions on both sides of the pair of front and back principal-surface film portions, to thereby form a joint region formed so as to expand in a V-shape, the joint region being formed by joining the side-surface film portion's end and the principal-surface film portions' ends extending along the short-side portion; and
the frozen food-containing bag product is constructed such that, in a state where the bag, containing the thawed or heated food and having been taken out from a microwave oven, is arranged in a manner that the side-surface film portion on the side of one of the long-side portions of the principal-surface film portions comes to a lower side, the inwardly-folded V-shape state of the side-surface film portion arranged on the lower side is opened-up by employing a weight of the thawed or heated food, and the side-surface film portion, which is arranged on the lower side and whose inwardly-folded state has been opened-up, serves as a placement portion and is placed on a receiving surface, on which the bag is to be placed, by employing the weight of the thawed or heated food, and
a section on the side of the other long-side portion of the principal-surface film portions is cut away along a long-side direction to thereby form a take-out opening in a manner that the food can be taken out through the formed take-out opening and be eaten.

2. The frozen food-containing bag product according to claim 1, wherein:
the bag is formed in a gusset bag shape using a film material so as to comprise a pair of front and back principal-surface film portions, each having a rectangular front-view shape, and
a pair of left and right side-surface film portions, each being folded inward in a V-shape and tucked-in at a section extending along one of the respective long-side portions which exist on both sides of each of the principal-surface film portions;
sections respectively extending along short-side portions, which exist on both sides of each of the front and back principal-surface film portions, are each joined together as joint portions, to thereby seal the frozen food inside the bag;
a steam discharging portion is formed in one of the front and back principal-surface film portions; and
in each of the joint portions respectively formed along the short-side portions on both sides of the pair of front and back principal-surface film portions,
each of the left and right side-surface film portions folded inward in a V-shape is not joined together, and
an end of each of the side-surface film portions is joined only to the front and back principal-surface film portions' ends extending along the respective short-side portions on both sides of the pair of front and back principal-surface film portions, to thereby form a joint region formed so as to expand in a V-shape, the joint region being formed by joining the side-surface film portion's end and the principal-surface film portions' ends extending along the short-side portion.

3. The frozen food-containing bag product according to claim 1, wherein the film material forming the bag is a laminate film material made from:a synthetic resin-made stretched film; anda synthetic resin-made unstretched film having heat-sealability and bonded to an inner side of the synthetic resin-made stretched film.

4. The frozen food-containing bag product according to claim 3, wherein the steam discharging portion comprises:
a low-melting-point heat-seal agent or release agent provided between the synthetic resin-made stretched film and the synthetic resin-made unstretched film and applied to the synthetic resin-made stretched film so as to extend in a belt-like shape; and
a cut line that is linearly cut in the synthetic resin-made stretched film so as to longitudinally traverse the belt-like zone, in which the low-melting-point heat-seal agent or release agent has been applied, along an extending direction of the belt-like zone, and
extend out from the belt-like zone up to a zone where the low-melting-point heat-seal agent or release agent is not applied.

5. The frozen food-containing bag product according to claim 4, wherein the steam discharging portion extends in a direction along the long-side direction of said one of the principal-surface film portions, and is provided closer to the side of the other long-side portion opposite from the side-surface film portion that becomes the placement portion on the side of said one of the long-side portions.

6. The frozen food-containing bag product according to claim 5, wherein the cut line of the steam discharging portion functions as a cut-away guide line when forming the take-out opening by cutting away the principal-surface film portions along the long-side direction after thawing or heating the food contained in the bag.

7. The frozen food-containing bag product according to claim 1, wherein the frozen food contained in the bag is frozen cooked rice.

8. A method for using the frozen food-containing bag product according to claim 1, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

9. The frozen food-containing bag product according to claim 2, wherein the film material forming the bag is a laminate film material made from:a synthetic resin-made stretched film; and a synthetic resin-made unstretched film having heat-sealability and bonded to an inner side of the synthetic resin-made stretched film.

10. The frozen food-containing bag product according to claim 2, wherein the frozen food contained in the bag is frozen cooked rice.

11. The frozen food-containing bag product according to claim 3, wherein the frozen food contained in the bag is frozen cooked rice.

12. The frozen food-containing bag product according to claim 4, wherein the frozen food contained in the bag is frozen cooked rice.

13. The frozen food-containing bag product according to claim 5, wherein the frozen food contained in the bag is frozen cooked rice.

14. The frozen food-containing bag product according to claim 6, wherein the frozen food contained in the bag is frozen cooked rice.

15. A method for using the frozen food-containing bag product according to claim 2, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

16. A method for using the frozen food-containing bag product according to claim 3, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

17. A method for using the frozen food-containing bag product according to claim 4, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

18. A method for using the frozen food-containing bag product according to claim 5, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

19. A method for using the frozen food-containing bag product according to claim 6, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.

20. A method for using the frozen food-containing bag product according to claim 7, the method comprising:
placing the bag product, which has the frozen food contained in the bag, in a microwave oven such that one of the principal-surface film portions having the bag's steam discharging portion faces upward;
thawing or heating the frozen food while causing steam to be discharged from the steam discharging portion by operating the microwave oven for a predetermined time with which the contained frozen food can be thawed or heated;
then taking out the bag product from the microwave oven, and moving the thawed or heated food to the side of the side-surface film portion which is located on the side of said one of the long-side portions of the bag, to open up the inwardly-folded V-shape state of the side-surface film portion on the side of said one of the long-side portions by the weight of the thawed or heated food, and thereby form a placement portion by the side-surface film portion on the side of said one of the long-side portions; and
by employing the weight of the thawed or heated food, placing the formed placement portion on a receiving surface on which the bag is to be placed, and in this state, cutting away a section on the side of the other long-side portion of the principal-surface film portions along the long-side direction and thereby forming a take-out opening in a manner that the food can be taken out through the formed take-out opening and be eaten.
